(19) United States
(12) Patent Application Publication
(10) Pub. No.: US 2026/0106474 A1
(43) Pub. Date: Apr. 16, 2026

(54) EARPHONE CHARGING BOX AND EARPHONE KIT

(71) Applicant: Luxshare Precision Industry Company Limited, SHENZHEN (CN)

(72) Inventor: GUOYI ZHANG, SHENZHEN (CN)

(73) Assignee: Luxshare Precision Industry Company Limited, SHENZHEN (CN)

(21) Appl. No.: 19/324,268

(22) Filed: Sep. 10, 2025

(30) Foreign Application Priority Data
Oct. 15, 2024 (CN) 202411446295.5

(51) Int. Cl. H02J 7/00; H04R 1/10

(52) U.S. Cl. CPC H02J 7/731; H04R 1/1025; H04R 1/1016

(57) ABSTRACT

Provided are an earphone charging box and earphone kit. The earphone charging box includes a lower case, an upper cover, a rotating member, and a sliding member. The lower case includes an earphone slot for accommodating an earphone. A bottom of the upper cover includes a sliding slot. The rotating member is arranged on the lower case. The sliding member is mounted on the top of the rotating member and is partially arranged in the sliding slot. The upper cover is connected to the lower case through the sliding member and the rotating member. The box earphone charging is opened or closed by rotating of the rotating member and sliding of the sliding member.

### CROSS-REFERENCE TO RELATED APPLICATION

This application claims the benefit of Chinese Patent Application No. 202411446295.5, filed on Oct. 15, 2024, entitled “Earphone Charging Box and Earphone Kit”, which is incorporated herein by reference in its entirety.

### FIELD

The present disclosure relates to the field of wireless earphone, and more particularly to an earphone charging box and an earphone kit.

### BACKGROUND

At present, an earphone charging box of a wireless earphone is opened by linear sliding or arc sliding. The wireless earphone is deeply received in such earphone charging box and is almost not exposed. As a result, the earphone is hard to take out from the earphone charging box. In addition, the earphone occupies too much space in the earphone charging box causing difficulty for arranging a battery and a mainboard.

### SUMMARY

Embodiments of the present disclosure provide an earphone charging box and an earphone kit. The earphone charging box is opened or closed by moving the upper cover by rotating of a rotating member and sliding a sliding member. It is easy take the earphone out of the earphone charging box and put the earphone in the earphone charging box, and the internal space of the earphone charging box can be reasonably allocated.

One aspect of embodiments of the present disclosure provides an earphone charging box. The earphone charging includes a lower case, an upper cover, a rotating member, and a sliding member. The lower case includes an earphone slot for accommodating an earphone. The upper cover is provided with a sliding slot on a side close to the lower case. An end of the rotating member is provided with a rotating shaft, and two ends of the rotating shaft are rotatably arranged on the lower case. The sliding member is fixedly arranged on a top of the rotating member and partially arranged in the sliding slot such that the upper cover is connected to the lower case through the sliding member and the rotating member. When the upper cover moves from a closing position to an opening position, the sliding member moves from a first end of the sliding slot to a second end of the sliding slot, and the rotating member rotates from a first position to a second position to deflect the upper cover. When the upper cover moves from the opening position to the closing position, the sliding member moves from the second end of the sliding slot to the first end of the sliding slot, and the rotating member rotates from the second position to the first position to deflect the upper cover.

In some embodiments, the earphone charging box further includes: rolling members. The rolling members are rotatably arranged on the lower case and located on two opposite sides of the rotating member. A bottom of the upper cover is provided with rails parallel to the sliding slot, and each rail includes a straight portion and a ramp portion. When the upper cover moves from the closing position to the opening position, the sliding member, the rolling members roll from the ramp portions to the straight portions. When the upper cover moves from the opening position to the closing position, the rolling members roll from the straight portions to the ramp portions.

In some embodiments, the bottom of the upper cover is provided with an avoidance groove, and a position of the avoidance groove matches the ramp portions.

In some embodiments, the lower case is provided with a first magnet, the rotating member is provided with a second magnet, and when the rotating member is at the first position, the second magnet is positioned to be aligned with the first magnet.

In some embodiments, the upper cover includes a third magnet and a fourth magnet. When the upper cover is at the closing position, the third magnet is positioned to be aligned with the second magnet, and when the upper cover is at the opening position, the fourth magnet is positioned to be aligned with the second magnet.

In some embodiments, the rotating member includes: a body fixedly connected to the sliding member; a connection part extending outward from an edge of the body and rotatably connected to the lower case via the rotating shaft; and a limiting part extending downward from a bottom of the body and abutting the lower case when the rotating member is at the second position.

In some embodiments, the lower case is provided with a first contour groove and a second contour groove, a limiting hole runs through a bottom of the first contour groove, the first contour groove and the body of the rotating member match each other, the second contour groove and the connection part match each other, and the limiting part is in the limiting hole.

In some embodiments, a bottom of the sliding slot is provided with a strip-shaped avoidance hole, and the sliding member includes: a sliding part located in the sliding slot and matching the bottom of the sliding slot, and a fixing part. The fixing part extends from a bottom of the sliding part, passes through the avoidance hole, and is fixedly connected to the rotating member.

In some embodiments, an edge of the avoidance hole is raised upward to form a wall, an edge of the sliding part extends downward to form a fitting portion, and the fitting portion is located between the wall and a side wall of the sliding slot.

In some embodiments, the lower case includes a case body and a first inner liner, and the earphone slot is formed on the first inner liner, the upper cover includes a cover body and a second inner liner in the cover body, and the sliding slot is formed on the second inner liner on a side close to the lower case.

Another aspect of embodiments of the present disclosure provides an earphone kit. The earphone kit includes an earphone charging box and an earphone accommodated in the earphone charging box. The earphone charging includes a lower case, an upper cover, a rotating member, and a sliding member. The lower case includes an earphone slot for accommodating the earphone. The upper cover is provided with a sliding slot on a side close to the lower case. An end of the rotating member is provided with a rotating shaft, and two ends of the rotating shaft are rotatably arranged on the lower case. The sliding member is fixedly arranged on a top of the rotating member and partially arranged in the sliding slot such that the upper cover is connected to the lower case through the sliding member and the rotating member. When the upper cover moves from a closing position to an opening position, the sliding member moves from a first end of the sliding slot to a second end of the sliding slot, and the rotating member rotates from a first position to a second position to deflect the upper cover. When the upper cover moves from the opening position to the closing position, the sliding member moves from the second end of the sliding slot to the first end of the sliding slot, and the rotating member rotates from the second position to the first position to deflect the upper cover.

In some embodiments, the earphone charging box includes: rolling members. The rolling members are rotatably arranged on the lower case and located on two opposite sides of the rotating member. A bottom of the upper cover is provided with rails parallel to the sliding slot, and each rail includes a straight portion and a ramp portion. When the upper cover moves from the closing position to the opening position, the sliding member, the rolling members roll from the ramp portions to the straight portions. When the upper cover moves from the opening position to the closing position, the rolling members roll from the straight portions to the ramp portions.

In some embodiments, the bottom of the upper cover is provided with an avoidance groove, and a position of the avoidance groove matches the ramp portions.

In some embodiments, the lower case is provided with a first magnet, the rotating member is provided with a second magnet, and when the rotating member is at the first position, the second magnet is positioned to be aligned with the first magnet.

In some embodiments, the upper cover includes a third magnet and a fourth magnet. When the upper cover is at the closing position, the third magnet is positioned to be aligned with the second magnet, and when the upper cover is at the opening position, the fourth magnet is positioned to be aligned with the second magnet.

In some embodiments, the rotating member includes: a body fixedly connected to the sliding member; a connection part extending outward from an edge of the body and rotatably connected to the lower case via the rotating shaft; and a limiting part extending downward from a bottom of the body and abutting the lower case when the rotating member is at the second position.

In some embodiments, the lower case is provided with a first contour groove and a second contour groove, a limiting hole runs through a bottom of the first contour groove, the first contour groove and the body of the rotating member match each other, the second contour groove and the connection part match each other, and the limiting part is in the limiting hole.

In some embodiments, a bottom of the sliding slot is provided with a strip-shaped avoidance hole, and the sliding member includes: a sliding part located in the sliding slot and matching the bottom of the sliding slot, and a fixing part. The fixing part extends from a bottom of the sliding part, passes through the avoidance hole, and is fixedly connected to the rotating member.

In some embodiments, an edge of the avoidance hole is raised upward to form a wall, an edge of the sliding part extends downward to form a fitting portion, and the fitting portion is located between the wall and a side wall of the sliding slot.

In some embodiments, the lower case includes a case body and a first inner liner, and the earphone slot is formed on the first inner liner, the upper cover includes a cover body and a second inner liner in the cover body, and the sliding slot is formed on the second inner liner on a side close to the lower case.

Embodiments of the present disclosure provide an earphone charging box and an earphone kit. The earphone charging box includes a lower case, an upper cover, a rotating member, and a rotating member. The lower case includes an earphone slot for accommodating earphone. A bottom of the upper cover includes a sliding slot. The rotating member is arranged on the lower case. The sliding member is mounted on the top of the rotating member and is partially arranged in the sliding slot so that the upper cover is connected to the lower case through the sliding member and the rotating member. When the upper cover moves from a closing position to an opening position, the sliding member moves from a first end to a second end of the sliding slot, and the rotating member rotates from a first position to a second position to deflect the upper cover. When the upper cover moves from the opening position to the closing position, the sliding member moves from the second end to the first end of the sliding slot, and the rotating member rotates from the second position to the first position to deflect the upper cover. Therefore, the earphone charging box is opened or closed by combination of rotating and sliding, it is easy take the earphone out of the earphone charging box and put the earphone in the earphone charging box, and the internal space of the earphone charging box can be reasonably allocated.

### BRIEF DESCRIPTION OF THE DRAWINGS

The various features and advantages of the disclosed examples will become apparent to those skilled in the art from the detailed description. The figures that accompany the detailed description can be briefly described as follows:

FIG. 1 is a perspective view of an earphone charging box in a closed state according to one or more embodiments of the present disclosure;

FIG. 2 is a perspective view of the earphone charging box in an opened state according to one or more embodiments of the present disclosure;

FIG. 3 is a schematic view of a lower case according to one or more embodiments of the present disclosure;

FIG. 4 is a schematic view of an upper cover according to one or more embodiments of the present disclosure;

FIG. 5 is an exploded schematic view of the earphone charging box according to one or more embodiments of the present disclosure;

FIG. 6 is a sectional view of the earphone charging box in the closed state according to one or more embodiments of the present disclosure;

FIG. 7 is a schematic view of a rotating member according to one or more embodiments of the present disclosure;

FIG. 8 is another schematic view of the rotating member from another viewing angle according to one or more embodiments of the present disclosure;

FIG. 9 is a perspective view of the earphone charging box in the closed state from another viewing angle according to one or more embodiments of the present disclosure;

FIG. 10 is a perspective view of the earphone charging box in an opened state according to one or more embodiments of the present disclosure;

FIG. 11 is a schematic view of a lower lining according to one or more embodiments of the present disclosure;

FIG. 12 is a schematic view of an upper lining according to one or more embodiments of the present disclosure; and

FIG. 13 is a schematic view of a sliding member according to one or more embodiments of the present disclosure.

### DESCRIPTION OF REFERENCE SIGNS

1: lower case; 11: earphone slot; 12: first magnet;
13: first contour groove; 14: second contour groove;
15: limiting hole; 16: case body; 17: lower inner lining;
2: upper cover; 21: sliding slot; 211: soft rubber;
22: rail; 221: straight portion; 222: ramp portion;
23: avoidance groove; 24: third magnet; 25: fourth magnet;
26: avoidance hole; 27: wall; 28: cover body; 29: second inner liner;
3: rotating member; 31: second magnet; 32: body;
33: connection part; 34: limiting part; 4: sliding member;
41: sliding part; 42: fixing part; 43: fitting portion.
5: rolling member; A: earphone charging box; B: earphone kit.

### DETAILED DESCRIPTION OF EMBODIMENTS

The present disclosure is described below on the basis of the embodiments, but is not merely limited to these embodiments. Specific details are described in detail in the following detailed description of the present disclosure. The present disclosure can also be fully understood by a person skilled in the art without the description of the details. In order to avoid confusing the essence of the present disclosure, commonly known method, process, flow, element and circuit are not described in detail.

In addition, it should be understood by those skilled in the art, the drawings herein are provided for the purpose of illustration, and the drawings are not necessarily to scale.

Unless otherwise stated, the terms “comprise”, “include” and the like in the entire application document shall be interpreted as inclusive rather than exclusive or exhaustive; in other words, the terms mean “include but not limited to”.

In the descriptions of the present disclosure, it should be understood that the terms like “first”, “second” and the like are used for the purpose of description only, but cannot be considered to indicate or imply relative importance. In addition, in the descriptions of the present disclosure, unless otherwise stated, the meaning of “a plurality of” is two or more.

Unless otherwise stated or defined, the terms “install”, “connected”, “connect”, “fix” and the like should be understood in a broad sense, for example, the term “connected” may be fixedly connected or detachably connected or integrally connected, may be mechanically connected or electrically connected, may be directly connected or indirectly connected by means of an intermediate medium, and may be internally communicated or have an interaction relationship between two elements. A person skilled in the art can understand the specific meanings of the above terms in the present disclosure according to specific circumstances.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

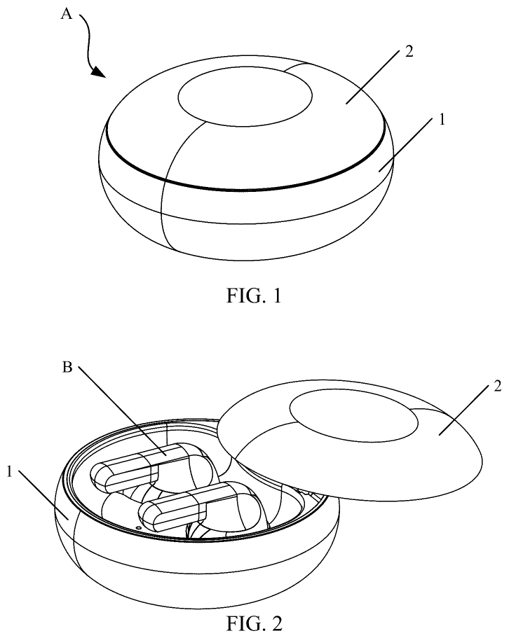

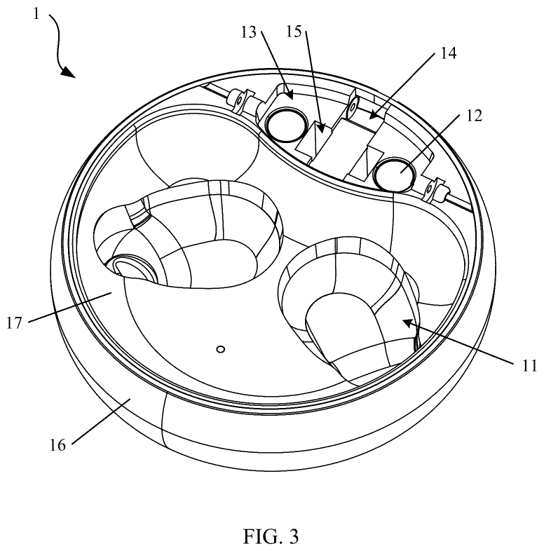

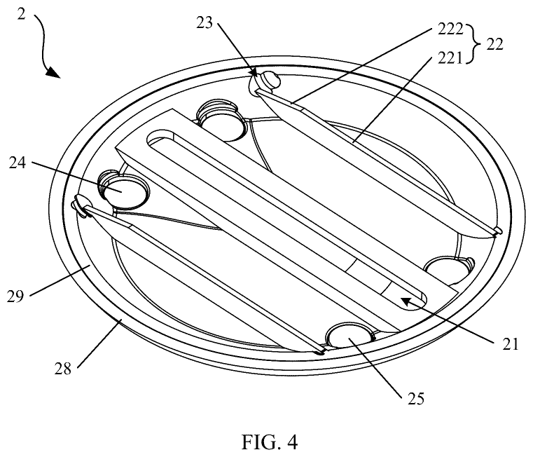

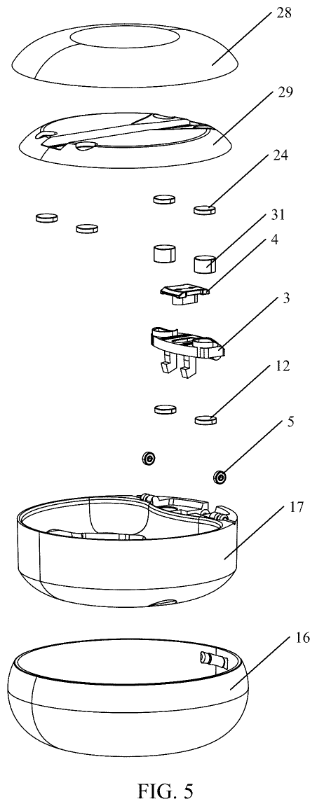

FIG. 1 is a perspective view of an earphone charging box in a closed state according to one or more embodiments of the present disclosure. FIG. 2 is a perspective view of the earphone charging box in an opened state according to one or more embodiments of the present disclosure. As shown in FIG. 1 and FIG. 2, an earphone charging box A includes a lower case 1 and an upper cover 2. FIG. 3 is a schematic view of the lower case according to one or more embodiments of the present disclosure. FIG. 4 is a schematic view of the upper cover according to one or more embodiments of the present disclosure. As shown in FIG. 3 and FIG. 4, the lower case 1 is provided with an earphone slot 11 for accommodating the earphone B, and the upper cover 2 is provided with a sliding slot 21 on a side close to the lower case 1. It is noted that the structure of the earphone slot 11 and the earphone B matches each other. FIG. 5 is an exploded schematic view of the earphone charging box according to one or more embodiments of the present disclosure. As shown in FIG. 5, the earphone charging box A further includes a rotating member 3 and a sliding member 4. It is noted that an end of the rotating member 3 is provided with a rotating shaft, two ends of the rotating shaft are rotatably arranged on the lower case 1, and the sliding member 4 is fixedly arranged on a top of the rotating member 3. It is noted that the sliding member 4 is partially arranged in the sliding slot 21 such that the upper cover 2 is connected to the lower case 1 through the sliding member 4 and the rotating member 3. In some embodiments, the rotating member 3 is made of Polycarbonate (PC)+20% Glass fiber (GF).

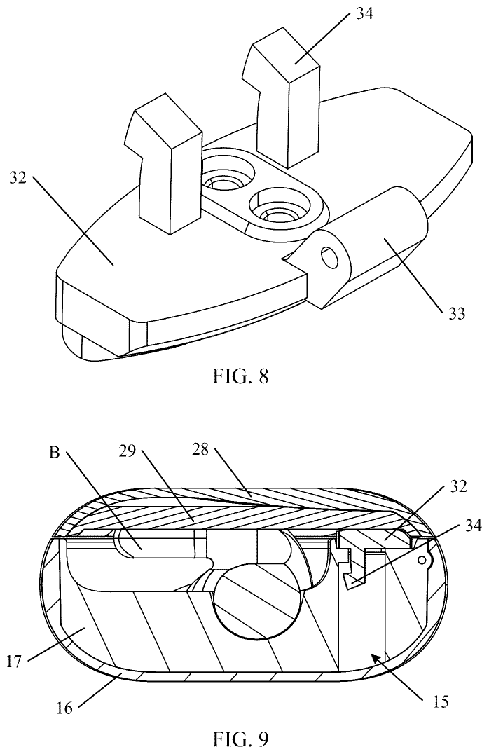

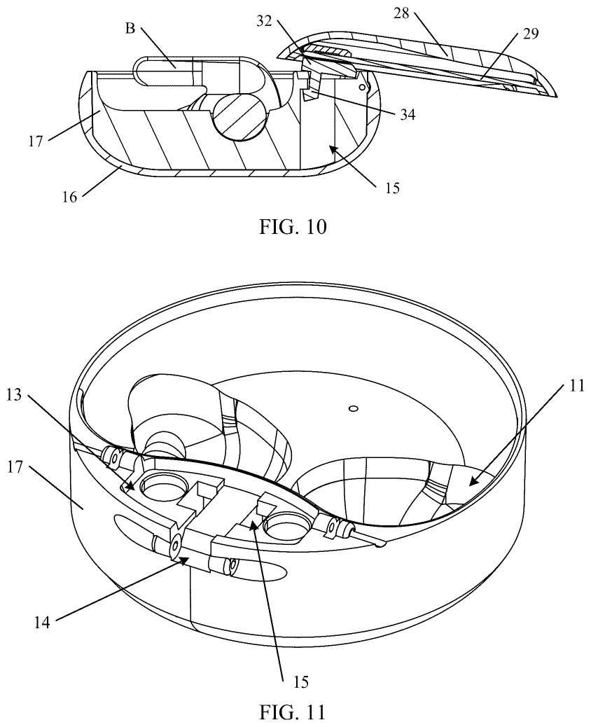

When a user opens the earphone charging case A to take the earphone B out of the earphone charging case A or to put the earphone B into the earphone charging case A, that is, when the user drives the upper cover 2 from the closing position to the opening position, the sliding member 4 moves from a first end to a second end of the sliding slot, at the same time, the rotating member 3 rotates from a first position (as shown in FIG. 9) to a second position (as shown in FIG. 10) to deflect the upper cover 2. Accordingly, when the user closes the earphone charging case A, that is, when the user drives the upper cover 2 from the opening position to the closing position, the sliding member 4 moves from the second end to the first end of the sliding slot 21, at the same time, the rotating member 3 rotates from the second position to the first position to deflect the upper cover 2. In this way, the upper cover 2 is driven by combination of rotating of the rotating member 3 and sliding of the sliding member 4, and thus, the earphone charging case A is opened or closed. The earphone B is easy to take out from the earphone charging case A or put into the earphone charging case A, and the internal space of the earphone charging box can be reasonably allocated.

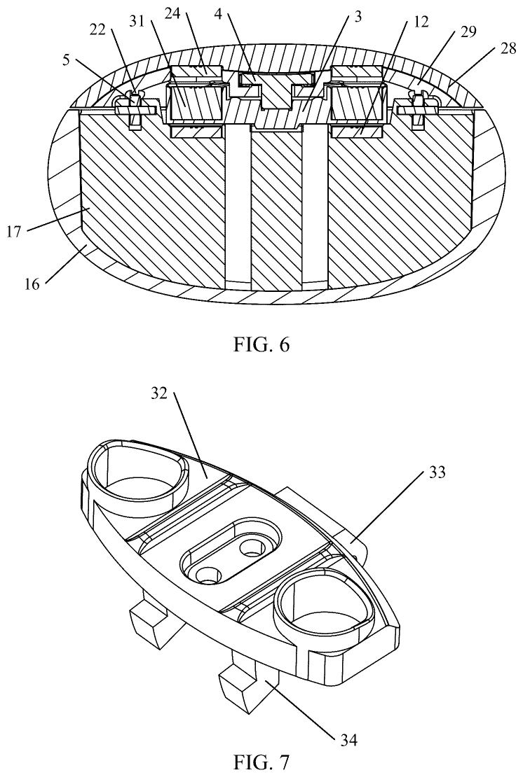

FIG. 6 is a sectional view of the earphone charging box in the closed state according to one or more embodiments of the present disclosure. In some embodiments, as shown in FIG. 5 and FIG. 6, the earphone charging box A further includes rolling members 5. For example, the rolling member 5 is configured as a rolling wheel structure and is made of stainless steel or plastic. In some embodiments, the rolling member 5 includes a rotating shaft, and thus is rotatably arranged on the lower case 1. The rotating shaft may be made of stainless steel or copper or aluminum or its alloy. In some embodiments, as shown in FIG. 4, a bottom of the upper cover 2 is provided with rails 22. It is noted that the rail 22 is parallel to the sliding slot 21 and includes a straight portion 221 and a ramp portion 222 having a certain inclination degree. Therefore, when the sliding member 4 slides along the sliding slot 21, the rolling member 5 rolls along the rail 22 synchronously. It is noted that the earphone charging box A includes two rolling members 5, and the two rolling members 5 are arranged on two opposite sides of the rotating member 3. Accordingly, the earphone charging box A includes two rails 22 corresponding to the rolling members 5 and are arranged on two sides of the sliding slot 21. The matching of the rolling members 5 and the rails 22 ensures the stability of sliding of the upper cover 2. When the upper cover 2 moves from the closing position to the opening position, the rolling member 5 rolls from the ramp portion 222 to the straight portion 221. Accordingly, when the upper cover 2 moves form the opening position to the closing position, the rolling member 5 rolls from the straight portion 221 to the ramp portion 222. It is noted that when the rolling member 5 rolls on the ramp portion 222, the sliding member 4 drives the upper cover 2 to slide, and the rotating member 3 drives the upper cover 2 to deflect synchronously with the rotating member 3. When the rolling member 5 rolls on the straight portion 221, the rotating member 3 is stationary, at the same time, the sliding member 4 drives the upper cover 2 to move straightly, and at the same time, the upper cover 2 slides at a certain inclination to avoid earphone B.

In some embodiments, as shown in FIG. 4, the bottom of the upper cover 2 is provided with an avoidance groove 23. It is noted that the position of the avoidance groove 23 matches the ramp portion 222 of the rail 22. For example, the avoidance groove 23 is provided on a side of the rail 22 where the ramp portion 222 is formed. Therefore, when the earphone charging box A is in the closed state (that is, when the upper cover 2 is in the closing position), the rolling member 5 is located at an end portion of the rail 22 on the side where the ramp portion 222 is formed, and is accommodated in the avoidance groove 23, thereby preventing the rolling member 5 and the upper cover 2 from interfering each other.

In some embodiments, as shown in FIG. 3, the lower case 1 is provided with a first magnet 12. Correspondingly, as shown in FIG. 6, the rotating member 3 is provided with a second magnet 31. It is noted that, when the rotating member 3 is at the first position, the second magnet 31 corresponds to the first magnet 12. When the earphone charging box A is in the closed state, the rotating member 3 is stationary at the first position due to the suction force between the first magnet 12 and the second magnet 31, and thus, the upper cover 2 is stationary at the closing position. On the other hand, when the earphone charging box A is in the opened state, the first magnet 12 and the second magnet 31 are spaced apart from each other and staggered, but there is still a certain suction force between the first magnet 12 and the second magnet 31. In some embodiments, the lower case 1 is provided with a hole or groove for locating the first magnet 12, and the rotating member 3 is provided with a hole or groove for locating the second magnet 31. In some embodiments, there are two first magnets 12 spaced apart from each other and arranged on two sides of the sliding member 4, and accordingly, there are two second magnets 31 spaced apart from each other and arranged on two sides of the sliding member 4. In this way, the stability of the suction-fixing structure is improved, and the closing effect of the upper cover 2 is ensured.

In some embodiments, as shown in FIG. 4, the upper cover 2 is provided with a third magnet 24 and a fourth magnet 25. It is noted that when the upper cover 2 is in the closing position, the third magnet 24 is aligned with the second magnet 31. Therefore, when the earphone charging box A is in the closed state, the suction force between the first magnet 12, the second magnet 31 and the third magnet 24 makes the upper cover 2 be stationary at the closing position. Correspondingly, when the upper cover 2 is in the opening position, the fourth magnet 25 is aligned with the second magnet 31. Therefore, when the earphone charging box A is in the opened state, the suction force between the second magnet 31 and the fourth magnet 25 makes the upper cover 2 be stationary at the opening position. In some embodiments, the upper cover 2 is provided with hole or groove structures for locating the third magnet 24 and the fourth magnet 25. In some embodiments, there are two third magnets 24 which are space apart from each other and arranged on two sides of the sliding slot 21 respectively, and there are two fourth magnets 24 which are space apart from each other and arranged on two sides of the sliding slot 21 respectively. In this way, the stability of the suction-fixing structure is improved, and the closing-opening effect of the upper cover 2 is ensured. In some embodiments, the first magnet 12, the second magnet 31, the third magnet 24, and the fourth magnet 25 are N52M magnets, and are fixed by AB glue.

FIG. 7 is a schematic view of a rotating member according to one or more embodiments of the present disclosure. FIG. 8 is another schematic view of the rotating member viewing from another angle according to one or more embodiments of the present disclosure. In some embodiments, as shown in FIG. 7 and FIG. 8, the rotating member 3 includes a body 32, a connection part 33, and a limiting part 34. For example, the body 32 is fixedly connected to the sliding member 4. In some embodiments, the body 32 is a symmetrical plate-like structure, and is fixedly connected to the sliding member 4 by screw. Further, the body 32 is provided with a recess for accommodating the second magnet 31. Furthermore, the connection part 33 extends outward from an edge of the body 32, and is also rotatably connected to the lower case 1 via the rotating shaft made of stainless steel or copper or aluminum or their alloys. In addition, the limiting part 34 extends downward from a bottom of the body 32 and abuts the lower case 1 when the rotating member 3 is at the second position. FIG. 9 is a perspective view of the earphone charging box in the closed state from another viewing angle according to one or more embodiments of the present disclosure. FIG. 10 is a perspective view of the earphone charging box in an opened state according to one or more embodiments of the present disclosure. As shown in FIG. 9 and FIG. 10, when the upper cover 2 moves from the closing position to the opening position, the rotating member 3 is deflected, and the limiting effect of the limiting part 34 makes the rotating member 3 be fixed at the second position. In some embodiments, the lower end of the limiting part 34 protrudes toward a side, and the limiting part 34 has an L-shaped structure to abut the lower case 1.

In some embodiments, as shown in FIG. 3, the lower case 1 is provided with a first contour groove 13 and a second contour groove 14. A groove bottom of the first contour groove 13 is penetrated downward to form a limiting hole 15. It is noted that the first contour groove 13 and the body 32 match each other, the second contour groove 14 and the connection part 33 match each other, and the limiting part 34 is located in the limiting hole 15. The rotating member 3 is adapted to the structure of the lower case 1, making the structure of the earphone charging box A more compact. As shown in FIG. 9 and FIG. 10, when the upper cover 2 moves form the closing position to the opening position, the rotating member 3 is deflected, the limiting part 34 abuts the inner wall of the limiting hole 15 to achieve the limiting effect. In some embodiments, the inner wall of the limiting hole 15 protrudes toward the limiting part 34 so as to match the L-shaped structure of the limiting part 34. Therefore, the limiting hole 15 and the limiting part 34 work together to stop rotating of the rotating member 3.

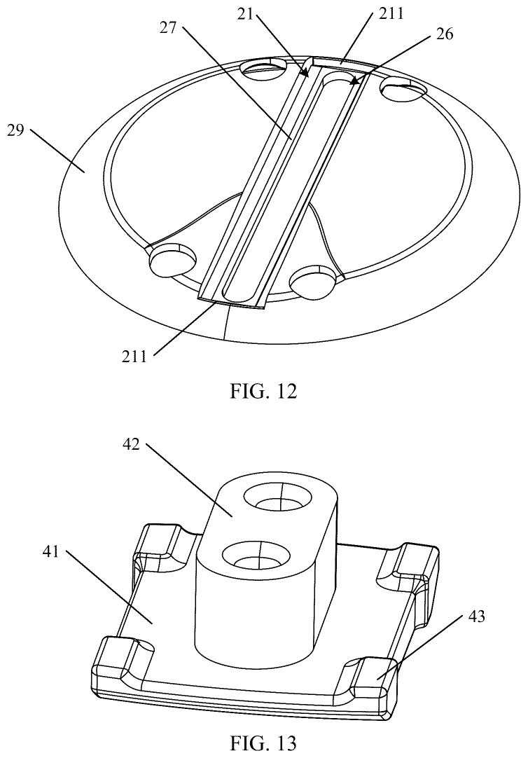

In some embodiments, as shown in FIG. 5, the lower case 1 includes a case body 16 and a lower inner lining 17 arranged in the case body 16, and the lower inner lining 17 is provided with an earphone slot 11. Correspondingly, the upper cover 2 includes a cover body 28 and an upper inner lining 29 arranged in the cover body 28, and the sliding slot 21 is formed on the upper inner lining 29 on a side close to the lower case 1. In some embodiments, the cover body 28 is made of PC. FIG. 11 is a schematic view of a lower lining according to one or more embodiments of the present disclosure. As shown in FIG. 3 and FIG. 11, the first magnet 12, the first contour groove 13, the second contour groove 14, and the limiting hole 15 are all formed on the lower inner lining 17. FIG. 12 is a schematic view of an upper lining according to one or more embodiments of the present disclosure. As shown in FIG. 4 and FIG. 12, the rail 22, the avoidance groove 23, the third magnet 24, and the fourth magnet 25 are all formed on the upper inner lining 29. It is noted that the structure of the earphone charging box A is adjusted according to the earphone B by adjusting the lower inner lining 17 and the upper inner lining 29, thereby improving the applicability and reducing cost.

In some embodiments, as shown in FIG. 12, the groove bottom of the sliding slot 21 is provided with a strip-shaped avoidance hole 26. FIG. 13 is a schematic view of a sliding member according to one or more embodiments of the present disclosure. As shown in FIG. 13, the sliding member 4 includes a sliding part 42 and a fixing part 42. In addition, the sliding part 42 is received in the sliding slot 21 and matches the slot bottom of the sliding slot 21. The fixing part 42 extends downward from the bottom of the sliding part 41, passes through the avoidance hole 26, and is fixedly connected to the rotating member 3. For example, the fixing part 42 is fixedly connected to the body 32 of the rotating member 3 by a screw. In some embodiments, the size of the sliding part 41 is greater than the size of the fixing part 42. Therefore, the upper cover 2 is capable of sliding through the coordination of the sliding member 4 and the sliding slot 21, and is also capable of being locked to the lower case 1 through the sliding member 4.

In some embodiments, as shown in FIG. 12, an edge of the avoidance hole 26 is raised upward to form a wall 27. Correspondingly, as shown in FIG. 13, the edge of the sliding part 41 extends downward to form a fitting portion 43. It is noted that the fitting portion 43 is arranged between the wall 27 and a side wall of the sliding groove 21. Therefore, when the upper cover 2 slides with respect to the sliding member 4, the fitting portion 43 is limited by the wall 27, which ensures the stability of the sliding of the upper cover 2.

In some embodiments, as shown in FIG. 12, each of two ends of the sliding slot 21 is provided with a soft rubber 211. It is noted that when the sliding member 4 along the sliding slot 21 to the first end or the second end of the sliding slot 21, the corresponding soft rubber 211 provides stopping and cushion effect for the sliding member 4.

Embodiments of the present disclosure further provide an earphone kit. The earphone kit includes an earphone charging box A and an earphone B. It is noted that the structure of the earphone charging box A has been described above and is not repeated here. The earphone B is accommodated in the earphone charging box A. When a user uses the earphone kit, the earphone charging box A is opened or closed by moving the upper cover 2 by sliding and rotating. Therefore, the upper cover 2 avoids the earphone B, and it is easy to take out the earphone B or put the earphone B into the box.

Embodiments of the present disclosure provide an earphone charging box and an earphone kit. The earphone charging box includes a lower case, an upper cover, a rotating member, and a rotating member. The lower case includes an earphone slot for accommodating earphone. A bottom of the upper cover includes a sliding slot. The rotating member is arranged on the lower case. The sliding member is mounted on the top of the rotating member and is partially arranged in the sliding slot so that the upper cover is connected to the lower case through the sliding member and the rotating member. When the upper cover moves from a closing position to an opening position, the sliding member moves from a first end to a second end of the sliding slot, and the rotating member rotates from a first position to a second position to deflect the upper cover. When the upper cover moves from the opening position to the closing position, the sliding member moves from the second end to the first end of the sliding slot, and the rotating member rotates from the second position to the first position to deflect the upper cover. Therefore, the earphone charging box is opened or closed by combination of rotating and sliding, it is easy take the earphone out of the earphone charging box and put the earphone in the earphone charging box, and the internal space of the earphone charging box can be reasonably allocated.

The descriptions above are only preferred embodiments of the present disclosure, but are not intended to limit the present disclosure. For a person skilled in the art, the present disclosure may have various changes and variations. Any modifications, equivalent substitutions, improvements and the like made within the spirit and principles of the present disclosure are all intended to be concluded in the protection scope of the present disclosure.

I/We claim:

1. An earphone charging box, comprising:
a lower case comprising an earphone slot for accommodating an earphone,
an upper cover provided with a sliding slot on a side close to the lower case;
a rotating member, wherein an end of the rotating member is provided with a rotating shaft, and two ends of the rotating shaft are rotatably arranged on the lower case; and
a sliding member, wherein the sliding member is fixedly arranged on a top of the rotating member and partially arranged in the sliding slot such that the upper cover is connected to the lower case through the sliding member and the rotating member,
wherein when the upper cover moves from a closing position to an opening position, the sliding member moves from a first end of the sliding slot to a second end of the sliding slot, and the rotating member rotates from a first position to a second position to deflect the upper cover, and
when the upper cover moves from the opening position to the closing position, the sliding member moves from the second end of the sliding slot to the first end of the sliding slot, and the rotating member rotates from the second position to the first position to deflect the upper cover.

2. The earphone charging box according to claim 1, further comprising: rolling members, wherein the rolling members are rotatably arranged on the lower case and located on two opposite sides of the rotating member;
wherein a bottom of the upper cover is provided with rails parallel to the sliding slot, and each rail comprises a straight portion and a ramp portion,
when the upper cover moves from the closing position to the opening position, the sliding member, the rolling members roll from the ramp portions to the straight portions;
when the upper cover moves from the opening position to the closing position, the rolling members roll from the straight portions to the ramp portions.

3. The earphone charging box according to claim 2, wherein the bottom of the upper cover is provided with an avoidance groove, and a position of the avoidance groove matches the ramp portions.

4. The earphone charging box according to claim 1, wherein the lower case is provided with a first magnet, the rotating member is provided with a second magnet, and when the rotating member is at the first position, the second magnet is positioned to be aligned with the first magnet.

5. The earphone charging box according to claim 4, wherein the upper cover comprises a third magnet and a fourth magnet,
when the upper cover is at the closing position, the third magnet is positioned to be aligned with the second magnet, and when the upper cover is at the opening position, the fourth magnet is positioned to be aligned with the second magnet.

6. The earphone charging box according to claim 1, wherein the rotating member comprises:
a body fixedly connected to the sliding member;
a connection part extending outward from an edge of the body and rotatably connected to the lower case via the rotating shaft; and
a limiting part extending downward from a bottom of the body and abutting the lower case when the rotating member is at the second position.

7. The earphone charging box according to claim 6, wherein the lower case is provided with a first contour groove and a second contour groove, a limiting hole runs through a bottom of the first contour groove, the first contour groove and the body of the rotating member match each other, the second contour groove and the connection part match each other, and the limiting part is in the limiting hole.

8. The earphone charging box according to claim 1, wherein a bottom of the sliding slot is provided with a strip-shaped avoidance hole,
the sliding member comprises:
a sliding part located in the sliding slot and matching the bottom of the sliding slot; and
a fixing part, wherein the fixing part extends from a bottom of the sliding part, passes through the avoidance hole, and is fixedly connected to the rotating member.

9. The earphone charging box according to claim 8, wherein an edge of the avoidance hole is raised upward to form a wall, an edge of the sliding part extends downward to form a fitting portion, and the fitting portion is located between the wall and a side wall of the sliding slot.

10. The earphone charging box according to claim 1, wherein the lower case comprises a case body and a first inner liner, and the earphone slot is formed on the first inner liner,
the upper cover comprises a cover body and a second inner liner in the cover body, and the sliding slot is formed on the second inner liner on a side close to the lower case.

11. An earphone kit, comprising:
an earphone charging box; and
an earphone accommodated in the earphone charging box,
wherein the earphone charging box comprises:
a lower case comprising an earphone slot for accommodating the earphone,
an upper cover provided with a sliding slot on a side close to the lower case;
a rotating member, wherein an end of the rotating member is provided with a rotating shaft, and two ends of the rotating shaft are rotatably arranged on the lower case; and
a sliding member, wherein the sliding member is fixedly arranged on a top of the rotating member and partially arranged in the sliding slot such that the upper cover is connected to the lower case through the sliding member and the rotating member,
wherein when the upper cover moves from a closing position to an opening position, the sliding member moves from a first end of the sliding slot to a second end of the sliding slot, and the rotating member rotates from a first position to a second position to deflect the upper cover, and
when the upper cover moves from the opening position to the closing position, the sliding member moves from the second end of the sliding slot to the first end of the sliding slot, and the rotating member rotates from the second position to the first position to deflect the upper cover.

12. The earphone kit according to claim 11, wherein the earphone charging box further comprises: rolling members, wherein the rolling members are rotatably arranged on the lower case and located on two opposite sides of the rotating member;
wherein a bottom of the upper cover is provided with rails parallel to the sliding slot, and each rail comprises a straight portion and a ramp portion,
when the upper cover moves from the closing position to the opening position, the sliding member, the rolling members roll from the ramp portions to the straight portions;
when the upper cover moves from the opening position to the closing position, the rolling members roll from the straight portions to the ramp portions.

13. The earphone kit according to claim 12, wherein the bottom of the upper cover is provided with an avoidance groove, and a position of the avoidance groove matches the ramp portions.

14. The earphone kit according to claim 11, wherein the lower case is provided with a first magnet, the rotating member is provided with a second magnet, and when the rotating member is at the first position, the second magnet is positioned to be aligned with the first magnet.

15. The earphone kit according to claim 14, wherein the upper cover comprises a third magnet and a fourth magnet,
when the upper cover is at the closing position, the third magnet is positioned to be aligned with the second magnet, and when the upper cover is at the opening position, the fourth magnet is positioned to be aligned with the second magnet.

16. The earphone kit according to claim 11, wherein the rotating member comprises:
a body fixedly connected to the sliding member;
a connection part extending outward from an edge of the body and rotatably connected to the lower case via the rotating shaft; and
a limiting part extending downward from a bottom of the body and abutting the lower case when the rotating member is at the second position.

17. The earphone kit according to claim 16, wherein the lower case is provided with a first contour groove and a second contour groove, a limiting hole runs through a bottom of the first contour groove, the first contour groove and the body of the rotating member match each other, the second contour groove and the connection part match each other, and the limiting part is in the limiting hole.

18. The earphone kit according to claim 11, wherein a bottom of the sliding slot is provided with a strip-shaped avoidance hole,
the sliding member comprises:
a sliding part located in the sliding slot and matching the bottom of the sliding slot; and
a fixing part, wherein the fixing part extends from a bottom of the sliding part, passes through the avoidance hole, and is fixedly connected to the rotating member.

19. The earphone kit according to claim 18, wherein an edge of the avoidance hole is raised upward to form a wall, an edge of the sliding part extends downward to form a fitting portion, and the fitting portion is located between the wall and a side wall of the sliding slot.

20. The earphone kit according to claim 11, wherein the lower case comprises a case body and a first inner liner, and the earphone slot is formed on the first inner liner,
the upper cover comprises a cover body and a second inner liner in the cover body, and the sliding slot is formed on the second inner liner on a side close to the lower case.
